(19) United States
(12) Patent Application Publication
(10) Pub. No.: US 2026/0237933 A1
(43) Pub. Date: Aug. 13, 2026

(54) SURGE PROTECTION DEVICE FOR WIRELESS COMMUNICATIONS

(71) Applicant: viaPhoton, Inc., Naperville, IL (US)

(72) Inventors: Steve Fischer, Windsor, CO (US); Walter Mark Hendrix, Dallas, TX (US); Keith Samuel Maranto, Frankfort, IL (US); Mark James Smrha, Chicago, IL (US)

(21) Appl. No.: 19/538,371

(22) Filed: Feb. 12, 2026

Related U.S. Application Data
(60) Provisional application No. 63/757,518, filed on Feb. 12, 2025.

(51) Int. Cl. H01R 13/502; H01R 12/59

(52) U.S. Cl. CPC H01R 13/502; H01R 12/592

(57) ABSTRACT

An enhanced surge protection device (SPD) includes a stacked SPD subassembly having a plurality of metal oxide varistor (MOV) layers, a return conductor plate and a negative conductor plate disposed at opposing outer sides of the MOV layers, and at least one ground plate disposed within the MOV layers. A return terminal is electrically coupled to the return conductor plate, a negative terminal electrically is coupled to the negative conductor plate, and a ground terminal is electrically coupled to the ground plate.

### CROSS-REFERENCE TO RELATED APPLICATIONS

This Application claims the benefit of U.S. Provisional Application Serial No. 63/757,518, filed February 12, 2025, which is hereby incorporated by reference for all purposes.

### BACKGROUND

Wireless communication systems deployed in outdoor environments are highly susceptible to transient voltage surges caused by lightning strikes and electrical faults. The infrastructure supporting these systems, including remote radio units, power supplies, and conductive power cabling, often resides at elevated locations such as cell towers, where exposure to atmospheric electrical discharges is significant. Surges traveling through the power and signal lines can damage critical equipment, resulting in service disruptions, increased maintenance costs, and potential equipment failures. To mitigate these risks, surge protection devices (SPDs) are commonly integrated into network infrastructure to divert excess electrical energy away from sensitive components and prevent catastrophic damage.

Conventional SPDs for wireless communication applications typically employ metal oxide varistors (MOVs) or gas discharge tubes (GDTs) to absorb and dissipate transient voltage spikes. However, these designs often suffer from inefficiencies related to their form factor, response time, and heat dissipation capabilities. Many conventional solutions require substantial spacing between components, leading to increased signal path lengths that reduce the effectiveness of surge suppression. Additionally, traditional SPD configurations frequently exhibit high let-through voltages, meaning that residual surge energy may still reach protected equipment, causing premature degradation or failure. In some cases, failure detection mechanisms in existing SPDs do not provide real-time monitoring or redundancy, leaving communication systems vulnerable until a failed SPD is manually replaced.

### SUMMARY

In one aspect, the invention provides a stacked surge protection device (SPD) subassembly configured as a modular MOV-based stack. The subassembly includes a stacked assembly having multiple metal oxide varistor (MOV) layers, with a return conductor plate disposed at a first outer side of the stack and a negative conductor plate disposed at an opposing outer side. One or more ground plates are disposed within the stack between the return and negative conductor plates. The subassembly further provides a return terminal electrically coupled to the return conductor plate, a negative terminal electrically coupled to the negative conductor plate, and a ground terminal electrically coupled to the ground plate(s), such that the stacked arrangement can be electrically coupled into a power distribution path to provide a defined surge discharge path.

In another aspect, the invention provides an SPD that incorporates the stacked SPD subassembly into a power distribution path using an integration structure selected to suit different deployment form factors. The SPD includes electrical interfaces coupled to the return conductor plate, the negative conductor plate, and the ground plate(s), and further includes an integration structure configured to incorporate the stacked SPD subassembly into the power distribution path. In implementations, the integration structure comprises a plug-in module housing configured for installation in a junction box, an inline cable housing configured for inline installation with a power cable, or a multilayer printed circuit board assembly or laminated busbar supporting the stacked SPD subassembly. The SPD further includes a contactor assembly having a fixed contact, a movable contact, and a spring biasing the movable contact relative to the fixed contact, where the contactor assembly is configured to change an electrical continuity state responsive to a failure condition associated with at least one MOV layer of the stacked SPD subassembly.

In a further aspect, the invention provides a method of surge protecting wireless communications equipment using the stacked SPD subassembly as installed within the SPD architecture described above. The method includes providing a power distribution path including return, negative, and ground conductors; installing the SPD into the power distribution path by electrically coupling the return conductor to the return electrical interface, the negative conductor to the negative electrical interface, and the ground conductor to the ground electrical interface; and incorporating the stacked SPD subassembly into the power distribution path using the integration structure. During a surge event, surge current is conducted through the stacked SPD subassembly to clamp a transient voltage, and the method may further include changing the electrical continuity state of the contactor assembly to provide a failure indication and electrically isolating at least one failed MOV layer using a disconnect arrangement.

Other aspects of the invention will be apparent from the following description and the appended claims.

### BRIEF DESCRIPTION OF DRAWINGS

FIG. 1 is an environmental view of a representative cell site in accordance with one or more embodiments of the invention.

FIGS. 2A–2B illustrate a surge protection device (SPD) subassembly in accordance with one or more embodiments of the invention.\

FIGS. 3A–3B illustrate an inline-deployable SPD subassembly and associated cabling, in accordance with one or more embodiments of the invention.

FIGS. 4A–4B illustrate a stacked MOV arrangement and a corresponding electrical representation, in accordance with one or more embodiments of the invention.

FIGS. 5A–5B illustrate stacked-layer variations of the SPD of FIGS. 4A–4B, in accordance with one or more embodiments of the invention.

FIGS. 6A–6B illustrate a plug-in embodiment incorporating an SPD subassembly, in accordance with one or more embodiments of the invention.

FIGS. 7A–7B illustrate an inline SPD subassembly implementation, in accordance with one or more embodiments of the invention.

FIGS. 8A–8B illustrate an inline housing configuration and an integrated inductor option, in accordance with one or more embodiments of the invention.

FIGS. 9A–9B illustrate a multi-element SPD subassembly and a support structure, in accordance with one or more embodiments of the invention.

FIG. 10 is a schematic diagram illustrating an SPD subassembly having a primary protection stage and a secondary protection stage, in accordance with one or more embodiments of the invention.

FIG. 11 is a schematic diagram illustrating an SPD subassembly including multiple spring-loaded contact(s) in accordance with one or more embodiments of the invention.

FIGS. 12A–12B illustrate disconnect implementations for an SPD subassembly, in accordance with one or more embodiments of the invention.

FIGS. 13A–13B illustrate a bladed disconnect implementation for an SPD subassembly, in accordance with one or more embodiments of the invention.

FIGS. 14A–14C illustrate a controlled disconnect implementation incorporating a thermal switch and a heater, in accordance with one or more embodiments of the invention.

FIG. 15 is a flow diagram illustrating a method of surge protecting equipment, in accordance with one or more embodiments of the invention.

Like elements in the various figures are denoted by like reference numerals for consistency.

### DETAILED DESCRIPTION

The present disclosure relates to surge protection architectures for power distribution paths used in wireless communications installations, including tower-mounted and equipment-adjacent deployments. In representative environments, transient events can couple onto return and negative conductors and propagate toward radio-side loads, while conventional placements and interconnect geometries can introduce conductor-path length, turns, and separation between the clamp element and the protected interface. The disclosed approach organizes the surge suppression function around a stacked metal oxide varistor (MOV) subassembly that is configured to be electrically coupled to return, negative, and protective earth ground conductors using plate-defined current paths and a defined discharge path to ground.

In one aspect, the invention provides a stacked MOV arrangement that includes opposing outer conductor plates for return and negative, with one or more ground plates disposed within the stack and electrically coupled to protective earth. The stacked construction supports interleaving of MOV layers and ground plates, optional inclusion of thermally insulative separation layers between internal layers, and conductor-plate thickness selections that support current-carrying and thermal behavior targets in a given package. The stacked MOV subassembly is configured as a reusable core that can be incorporated into different integration structures, including a plug-in module configured for installation in a junction enclosure, an inline cable housing configured for installation within a cable segment, and a multilayer PCBA or laminated busbar that supports one or more stacked subassemblies along a length of the support structure.

In further aspects, the disclosed architectures support staged and service-oriented behaviors using structural features integrated with the stacked MOV core. Multi-stage implementations provide a primary surge suppression stage coupled to protective earth and a secondary stage coupled between return and negative, enabling continued clamping behavior under defined failure conditions. Inline implementations further support integration of series inductors within the same housing as the stacked MOV subassembly, while monitoring and maintenance functions are supported through contactor-based failure indication and controlled disconnect arrangements configured to electrically isolate a failed MOV by opening a defined conductor path using a meltable link, a fuse, a solder-release mechanism with spring-driven separation, and/or a heater/thermal-switch-driven release.

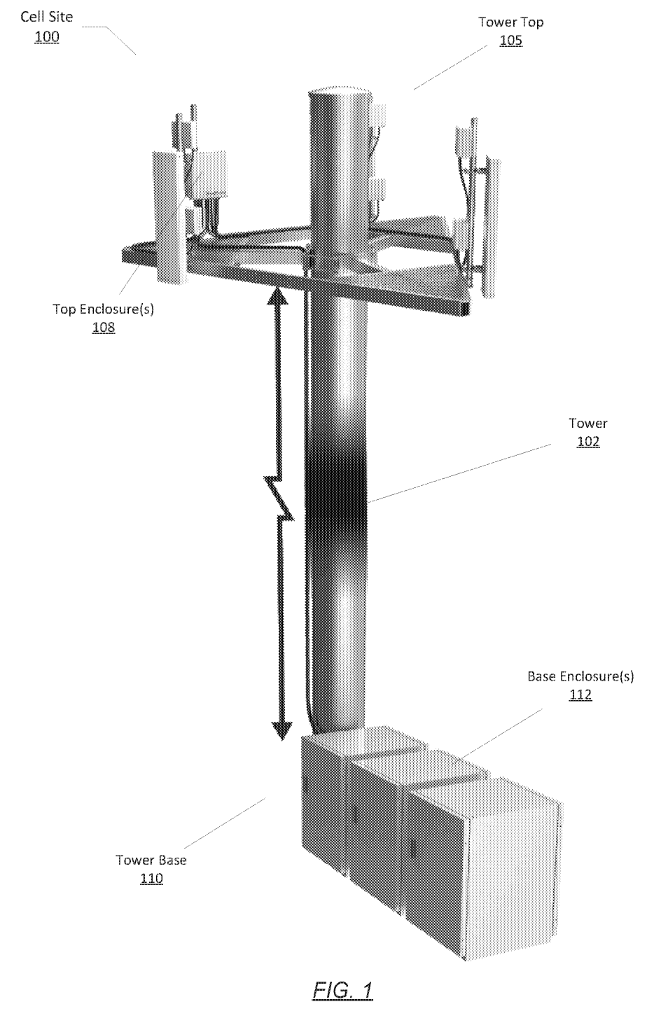

Referring now to FIG. 1, a cell site (100) includes an installation environment in which surge protection devices are deployed at physically separated locations and are coupled by cabling routed along a tower. In the illustrated arrangement, at least a portion of the protected conductor paths extend between equipment located proximate to a tower top (105) and equipment located proximately to a tower base (110), such that surge suppression and monitoring functions may be distributed across the site.

A tower (102) supports tower-top equipment and provides a routing structure for conductor paths extending between the tower top (105) and the tower base (110). In use, the tower (102) carries one or more conductor runs routed downward from the tower top (105) toward the tower base (110), and the conductor runs may serve as both protected conductors and as a conductive medium through which operating state information for surge protection devices can be interrogated and observed from a remote location.

The tower top (105) represents a tower-mounted region of the cell site (100) at which equipment and enclosures are positioned in proximity to radio hardware. In the illustrated arrangement, the tower top (105) is associated with one or more elevated mounting structures and conductor routing features, and cabling is shown routed between multiple tower-top devices and toward the tower (102) for descent to the tower base (110).

One or more top enclosures (108) are positioned at or proximate the tower top (105) and define an enclosed volume for housing tower-top components associated with protected conductor paths. In some embodiments, at least one top enclosure (108) houses a tower-top surge protection device (TT-SPD) that is coupled to one or more conductor paths routed between tower-top equipment and tower-base equipment. The top enclosure(s) (108) provides an interface location at which conductor paths enter and exit the enclosure, and the conductor paths are routed from the enclosure toward the tower (102) for descent to the tower base (110).

The tower base (110) represents a ground-level region of the cell site (100) at which equipment cabinets and enclosures are positioned and at which tower-routed cabling terminates or is redistributed. In use, conductor paths routed down the tower (102) from the tower top (105) are received proximate to the tower base (110) and may be coupled to additional equipment, including base-located surge protection devices and monitoring components.

One or more base enclosures (112) are positioned at or proximate the tower base (110) and define an enclosed volume for housing base-located components associated with protected conductor paths. In some embodiments, at least one base enclosure (112) houses a tower-base surge protection device (TB-SPD) that is coupled to the same conductor path as a corresponding TT-SPD housed at the tower top (105), thereby providing distributed surge suppression along the tower-routed conductor run. In further embodiments, a monitoring component located at or near the base enclosure(s) (112) is configured to interrogate the conductor path and to determine an operating state of one or more surge protection devices at the tower top (105) and/or the tower base (110) based on electrical behavior observed on the conductor path.

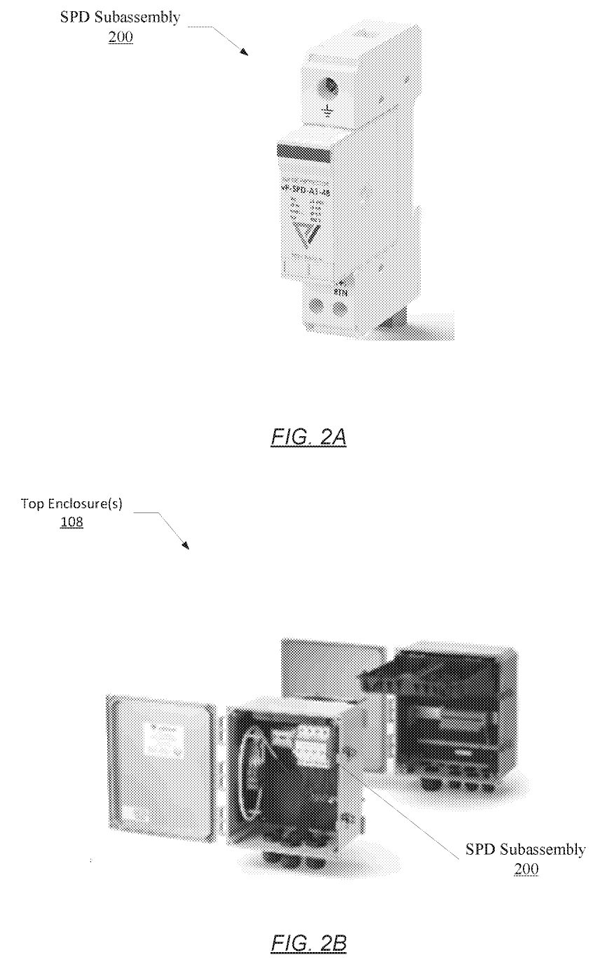

FIG. 2A illustrates an SPD subassembly (200) configured as a plug-in surge protection module that implements a stacked MOV arrangement within an integration structure, such that the stacked MOV arrangement can be incorporated into different external form factors while maintaining a defined discharge path for surge current.

The SPD subassembly (200) includes a module housing that supports installation into an enclosure or mounting base and that contains the stacked MOV arrangement and associated conductor plates. In some embodiments, the housing includes one or more exterior faces that present electrical interfaces for a return conductor, a negative conductor, and a ground conductor, thereby permitting the SPD subassembly (200) to be inserted into a protected power distribution path as a replaceable unit.

The SPD subassembly (200) further includes contact structures configured to couple the electrical interfaces of the module to corresponding site wiring within a junction box or enclosure. For example, the return and negative connections may be established via screw-down terminals, terminal plates, spring contacts, and/or blind-mate contact features that electrically couple to respective conductor plates of the stacked MOV arrangement, while a ground conductor may be coupled to a ground plate or ground tab of the stacked MOV arrangement via a direct connection interface.

In some embodiments, the SPD subassembly (200) is arranged such that protected circuit connections are positioned in close proximity to the stacked MOV arrangement, and such that the surge dissipation path from the module electrical interfaces to the stacked MOV arrangement and then to ground is defined by conductor plates and contact structures that reduce the length and number of turns of the surge current path within the module.

FIG. 2B illustrates one or more top enclosures (108), previously introduced with reference to FIG. 1, in an example installation context in which the top enclosure(s) (108) house one or more surge protection components positioned proximate to tower-top equipment. In the illustrated arrangement, a top enclosure (108) is shown with an access cover opened to expose an interior region configured to receive the SPD subassembly (200) and to route conductors between external cable entry locations and internal termination points.

The top enclosure(s) (108) further includes internal mounting structure for supporting the SPD subassembly (200) in a defined position relative to termination hardware and/or distribution hardware within the enclosure. In some embodiments, the SPD subassembly (200) is mounted so that its return, negative, and ground electrical interfaces are aligned with corresponding conductors within the enclosure, enabling the SPD subassembly (200) to be electrically coupled into the power distribution path that supplies tower-top loads while providing a discharge path for surge current to a ground conductor.

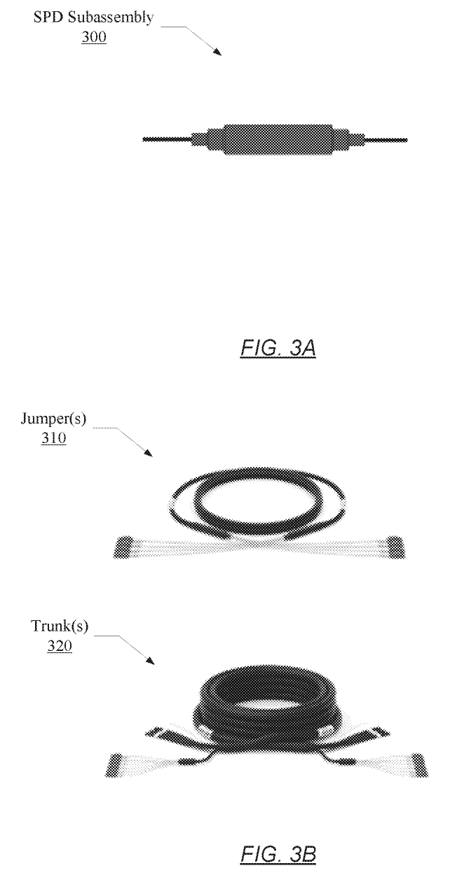

FIG. 3A illustrates an SPD subassembly (300) configured for in-line installation along a power distribution path. The SPD subassembly (300) is shown as an elongate body arranged between opposing cable portions such that power conductors enter the SPD subassembly (300) from a first side and exit from a second side. In use, the SPD subassembly (300) is incorporated into a tower power cable segment and positioned along the cable run to establish a surge dissipation path for transient events before the transient reaches equipment coupled to the cable.

The SPD subassembly (300) includes a housing region that encloses surge suppression elements and that defines a longitudinal axis extending between opposing ends of the SPD subassembly (300). In some implementations, the housing region is configured with a stretched aspect ratio, such that the SPD subassembly (300) is elongated relative to its cross-sectional width to support integration into a cable assembly without substantially increasing an outer diameter of a host cable in which it is installed.

The SPD subassembly (300) is configured to be installed close to a radio or other protected equipment, such as at a distance that reduces the length of unprotected cable between the SPD subassembly (300) and the protected equipment. In this arrangement, the conductors that extend between the SPD subassembly (300) and the protected equipment define a shortened exposure length for surge propagation along the cable run.

FIG. 3B illustrates example cable assemblies usable with the in-line configuration of FIG. 3A, including one or more jumpers (310) and one or more trunks (320). The jumper(s) (310) and trunk(s) (320) represent different cable segments within a tower power distribution architecture, and each cable segment is configured to include power conductors that are protected by the SPD subassembly (300) when the SPD subassembly (300) is incorporated into that segment.

Each jumper (310) is a cable segment configured to provide an interconnection between adjacent system elements, such as between a junction enclosure and tower-top equipment or between an equipment interface and a distribution interface. The jumper (310) is shown with end terminations that support coupling to corresponding mating connectors or termination hardware, such that the jumper (310) can be installed and removed as a discrete segment within the overall power cable run. In some implementations, the SPD subassembly (300) is incorporated into a jumper (310) by installing the SPD subassembly (300) inline between opposing jumper cable portions, thereby providing surge suppression along the jumper (310).

Each trunk (320) is a cable segment configured as a longer run segment of the tower power distribution architecture, such as between equipment regions at a tower base and a tower top. The trunk (320) is shown as a coiled cable assembly having end terminations for connection to corresponding power distribution interfaces. In some implementations, the SPD subassembly (300) is incorporated into a trunk (320) by installing the SPD subassembly (300) inline between opposing trunk cable portions along the run length, thereby providing surge suppression along the trunk (320) while maintaining an inline installation profile enabled by the elongate housing region of the SPD subassembly (300).

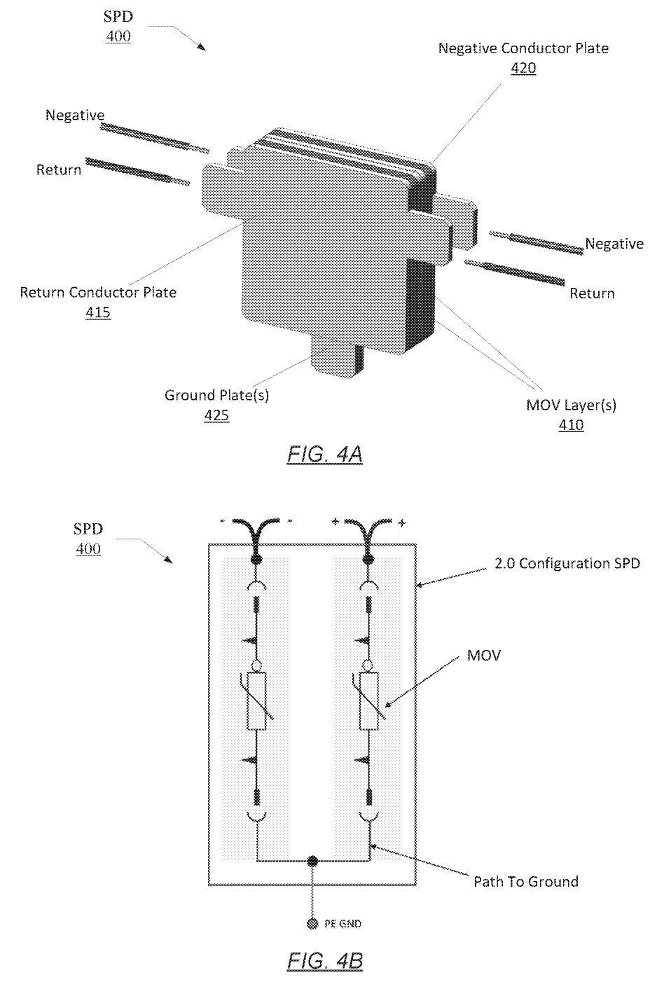

FIGS. 4A–4B illustrate a surge protection device (SPD) (400) implementing a stacked MOV arrangement in which a return-side connection and a negative-side connection are each provided with a surge discharge path to protective earth through one or more MOV elements and one or more ground plates. FIG. 4A depicts an example physical layer-stack construction of the SPD (400), and FIG. 4B depicts an electrical representation of an example “2.0 configuration” defining a path to ground.

The SPD (400) is arranged as a plate-and-layer stack in which outer conductor plates bound an internal stack region that contains MOV material and ground plate material. In the illustrated implementation, the stack includes opposed side regions configured for electrical coupling to a return conductor and a negative conductor and includes a ground output region configured for coupling to a protective earth ground conductor.

The MOV layer(s) (410) are disposed within the stack to provide voltage clamping behavior in response to surge-generated potential differences. In the configuration depicted in FIG. 4B, the MOV layer(s) (410) defines at least two MOV elements, each electrically positioned between a respective line conductor connection and a ground connection, such that surge current is diverted from the line conductor to ground when a threshold condition is reached.

The return conductor plate (415) is disposed at a first outer side of the stack and provides a conductive interface for the return-side connection of the SPD (400). In FIG. 4A, the return conductor plate (415) includes a plate body and one or more lateral extension portions that present connection regions for coupling a return conductor into and/or out of the SPD (400), such that the SPD (400) can be incorporated into a return conductor path while maintaining a plate-defined current path into the stack region.

The negative conductor plate (420) is disposed at a second outer side of the stack opposite the return conductor plate (415) and provides a conductive interface for the negative-side connection of the SPD (400). In FIG. 4A, the negative conductor plate (420) includes a plate body and one or more lateral extension portions that present connection regions for coupling a negative conductor into and/or out of the SPD (400), such that the negative conductor plate (420) defines a plate-based current path into the stack region.

The ground plate(s) (425) are disposed within the stack between the return conductor plate (415) and the negative conductor plate (420) and provide a ground reference electrode and discharge path for the MOV layer(s) (410). In some embodiments, the ground plate(s) (425) include one plate per MOV subassembly or a shared plate depending on circuit configuration, and adjacent ground plates may be in contact but not bonded to accommodate thermal expansion differences. In FIG. 4A, the ground plate(s) (425) includes a tab or projection configured to provide a ground output interface for coupling to a protective earth ground conductor.

FIG. 4B schematically represents the SPD (400) in a “2.0 configuration” in which two MOV elements (corresponding to the MOV layer(s) (410)) are each coupled between a respective line-side node and a common ground node, with the common ground node coupled to protective earth ground (PE GND). The depicted “path to ground” corresponds to the conductive path provided through the ground plate(s) (425) and associated ground interface, such that surge current conducted by either MOV element is directed to protective earth during a surge event.

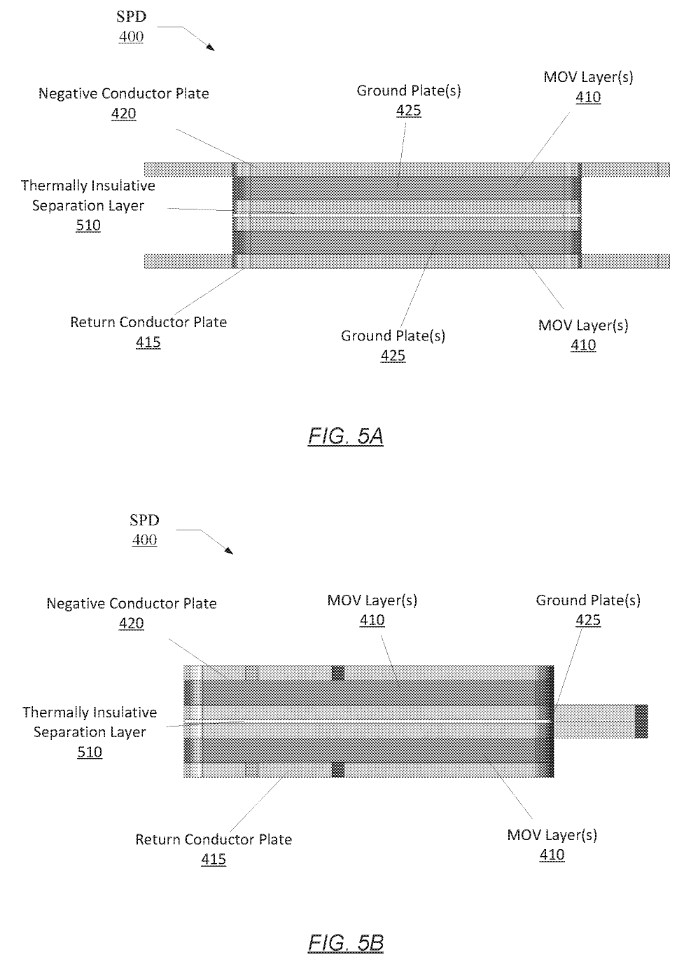

### Detailed Description of FIG. 5

FIGS. 5A–5B illustrate the surge protection device (SPD) (400) in a stacked-layer configuration that includes MOV layer(s) (410), ground plate(s) (425), and a thermally insulative separation layer (510) arranged between outer conductor plates, including a return conductor plate (415) and a negative conductor plate (420).

The SPD (400) is shown as a plate-bounded stack in which the return conductor plate (415) and the negative conductor plate (420) define opposing outer sides of an internal stack region. The internal stack region includes at least two MOV layer(s) (410) and at least one ground plate(s) (425), with the thermally insulative separation layer (510) disposed between adjacent internal layers as shown.

The negative conductor plate (420) is positioned on a first outer side of the SPD (400) and defines a conductive electrode facing a first side of the internal stack region. In FIG. 5A, the negative conductor plate (420) extends laterally beyond the internal stack region to provide a connection region. In FIG. 5B, the negative conductor plate (420) is shown extending beyond the internal stack region at a selected side to support a defined routing and termination arrangement for a negative conductor connection in an integrated assembly.

The return conductor plate (415) is positioned on a second outer side of the SPD (400) opposite the negative conductor plate (420) and defines a conductive electrode facing a second side of the internal stack region. In FIG. 5A, the return conductor plate (415) extends laterally beyond the internal stack region to provide a connection region. In FIG. 5B, the return conductor plate (415) is shown extending beyond the internal stack region at a selected side to support a defined routing and termination arrangement for a return conductor connection in an integrated assembly.

The MOV layer(s) (410) are disposed within the internal stack region between the outer conductor plates and the ground plate(s) to provide voltage-clamping behavior in response to surge-generated potential differences. In the illustrated stacked arrangement, a first MOV layer (410) is positioned proximate to the negative conductor plate (420) and a second MOV layer (410) is positioned proximate to the return conductor plate (415), with the ground plate(s) (425) disposed between the MOV layer(s) (410) to provide a ground reference electrode for surge diversion.

The ground plate(s) (425) are disposed within the internal stack region between the negative conductor plate (420) and the return conductor plate (415) and are electrically couplable to protective earth. In FIG. 5A, the ground plate(s) (425) are shown as internal plate layers interposed between the MOV layer(s) (410) and the thermally insulative separation layer (510). In FIG. 5B, the ground plate(s) (425) includes a plate portion that extends beyond the internal stack region to define a ground connection region on a side opposite at least one of the return and negative connection regions.

The thermally insulative separation layer (510) is disposed between adjacent internal layers of the SPD (400) to reduce heat transfer between the MOV layer(s) (410) and to distribute surge-generated thermal energy across the stack. In FIGS. 5A–5B, the thermally insulative separation layer (510) is depicted as one or more interposed layers arranged between internal conductive layers, and the separation layer (510) may be implemented as an optional layer selected based on surge-energy and thermal-management targets for a given deployment form factor.

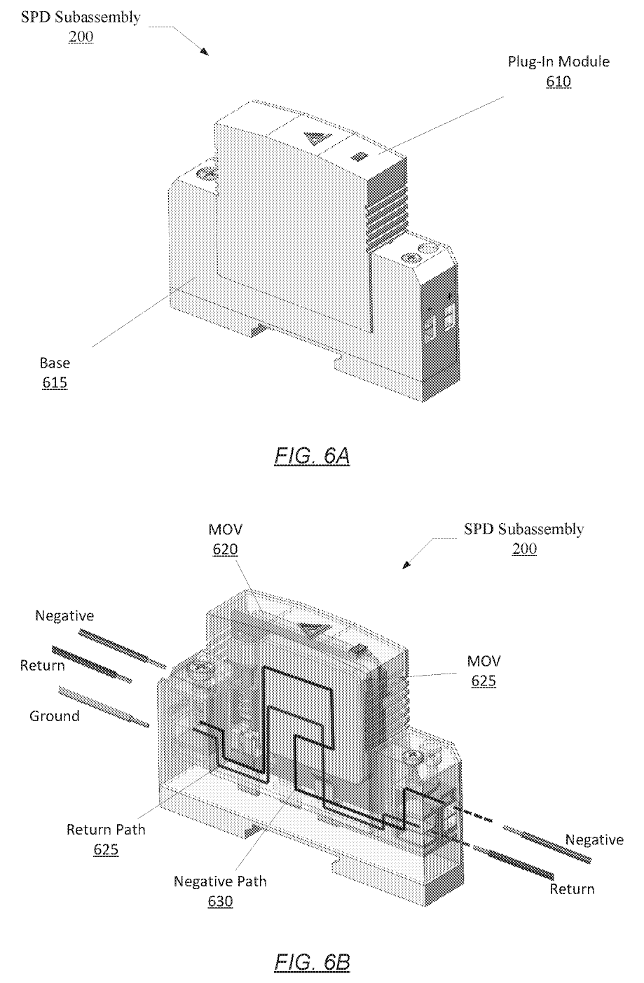

FIGS. 6A–6B illustrate a plug-in implementation in which the SPD subassembly (200) is integrated into a plug-in module (610) that is supported by a base (615). FIG. 6A shows an exterior view of the plug-in module (610) installed on the base (615), and FIG. 6B shows an internal view depicting example conductor routing for return and negative conductors through the assembly, together with multiple MOV elements.

The SPD subassembly (200) is shown in FIGS. 6A–6B as a replaceable module configured to be installed into, and removed from, the base (615) while maintaining defined electrical interfaces for the protected circuit conductors and for a ground conductor. In this plug-in arrangement, the SPD subassembly (200) positions surge suppression elements proximate to the protected-circuit connection region to establish a structured surge discharge path to ground.

The plug-in module (610) defines a housing portion of the SPD subassembly (200) that encloses internal surge suppression components, including multiple MOV elements. In the illustrated configuration, the plug-in module (610) is configured to cooperate with the base (615) such that insertion of the plug-in module (610) establishes electrical coupling between internal conductor plates associated with the MOV elements and termination hardware presented by the base (615).

The base (615) supports the plug-in module (610) and provides termination structure for coupling site conductors to the SPD subassembly (200). In some embodiments, the base (615) includes screw-down connection structure for at least return and negative conductors and further includes a contact interface that electrically couples from the termination structure to a conductor plate of the SPD subassembly (200), including a spring contact and/or a blind-mate spring clip configured to engage a conductor plate when the plug-in module (610) is seated on the base (615).

The MOV (620) and the MOV (625) are disposed within the plug-in module (610) and are arranged to provide surge suppression for the protected circuit. In some embodiments, the MOV (620) and the MOV (625) correspond to stacked MOV layers within a stacked MOV arrangement, such that each MOV provides a defined clamping function and a defined discharge path through internal conductor plates to a ground conductor connection.

The return path (625) and the negative path (630) depict internal conductor routing through the SPD subassembly (200) between respective termination regions and the MOV elements. In the illustrated routing, the return path (625) extends between a return-side termination region and the MOV element region, and the negative path (630) extends between a negative-side termination region and the MOV element region, with the depicted paths configured to reduce path length and reduce directional changes between the customer connection region and the MOV conductor plate region.

The return, negative, and ground conductors shown adjacent the SPD subassembly (200) illustrate an example installation context in which the return and negative conductors are routed through the base (615) and the SPD subassembly (200) as series conductors, while the ground conductor is coupled to a ground plate of the stacked MOV arrangement to provide a discharge path to protective earth. In some embodiments, the ground conductor is directly coupled to the SPD ground conductor plate, while the return and negative conductors are coupled to respective conductor plates via the contact interfaces supported by the base (615).

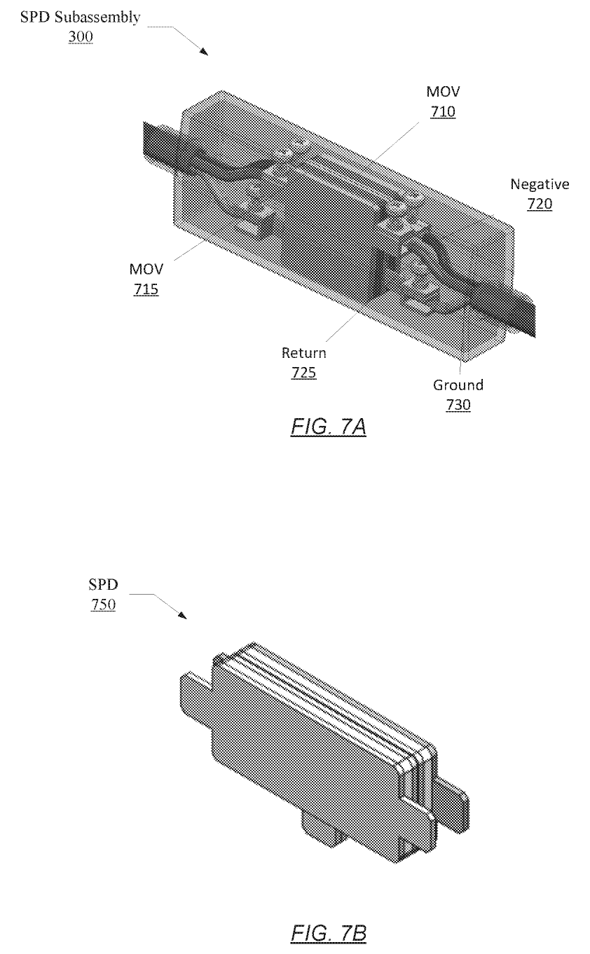

FIGS. 7A–7B illustrate an in-line implementation of the SPD subassembly (300), previously introduced with reference to FIG. 3, in which surge suppression elements are disposed within an in-line package and coupled to conductors of a power distribution path. FIG. 7A depicts the SPD subassembly (300) in an installed condition with conductor connections shown, and FIG. 7B depicts an SPD (750) as an internal stacked assembly usable within the SPD subassembly (300).

The SPD subassembly (300) includes a housing that defines an internal volume receiving surge suppression components and that provides opposing end regions for entry and exit of conductors. In the arrangement of FIG. 7A, the housing supports internal mounting and separation of the surge suppression elements relative to the negative connection (720), the return connection (725), and the ground connection (730), such that the surge suppression elements are positioned between the line conductors and the ground conductor.

The MOV (710) is disposed within the SPD subassembly (300) and is electrically coupled to provide a discharge path between a line-side node and the ground connection (730). In the illustrated configuration, the MOV (710) is coupled to an internal conductor structure that is, in turn, coupled to at least one of the negative connections (720) or the return connection (725), such that surge current can be diverted through the MOV (710) toward the ground connection (730).

The MOV (715) is disposed within the SPD subassembly (300) and is spaced from the MOV (710) within the housing. The MOV (715) is electrically coupled to provide a discharge path between a line-side node and the ground connection (730), and may be arranged to define a complementary surge diversion path relative to the MOV (710) such that both the negative connection (720) and the return connection (725) have respective discharge paths to ground.

The negative connection (720) is coupled to the SPD subassembly (300) at a first side of the housing and provides electrical continuity for a negative conductor routed through the in-line assembly. In some embodiments, the negative connection (720) is coupled to an internal conductor plate and/or bus structure by a screw-down termination interface such that the negative conductor is electrically continuous through the SPD subassembly (300) while also being electrically coupled to at least one surge suppression element.

The return connection (725) is coupled to the SPD subassembly (300) at a second side of the housing and provides electrical continuity for a return conductor routed through the in-line assembly. The return connection (725) is coupled to an internal conductor plate and/or bus structure by a termination interface so that the return conductor is electrically continuous through the SPD subassembly (300) while also being electrically coupled to at least one surge suppression element.

The ground connection (730) is coupled to the SPD subassembly (300) to provide a discharge path from internal ground plate structure. In the illustrated arrangement, the ground connection (730) is coupled to an internal ground plate and is positioned to receive surge current diverted through the MOV (710) and the MOV (715), such that the ground connection (730) functions as a common discharge node for the in-line assembly.

The SPD (750) of FIG. 7B corresponds to an internal stacked assembly configured for disposition within the SPD subassembly (300). The SPD (750) includes a layered body with laterally projecting tab portions configured for electrical coupling to the negative connection (720), the return connection (725), and the ground connection (730) through internal conductor structures of the SPD subassembly (300), and the layered body corresponds to the stacked conductor plate, MOV layer, and ground plate constructions described with reference to FIGS. 4–5.

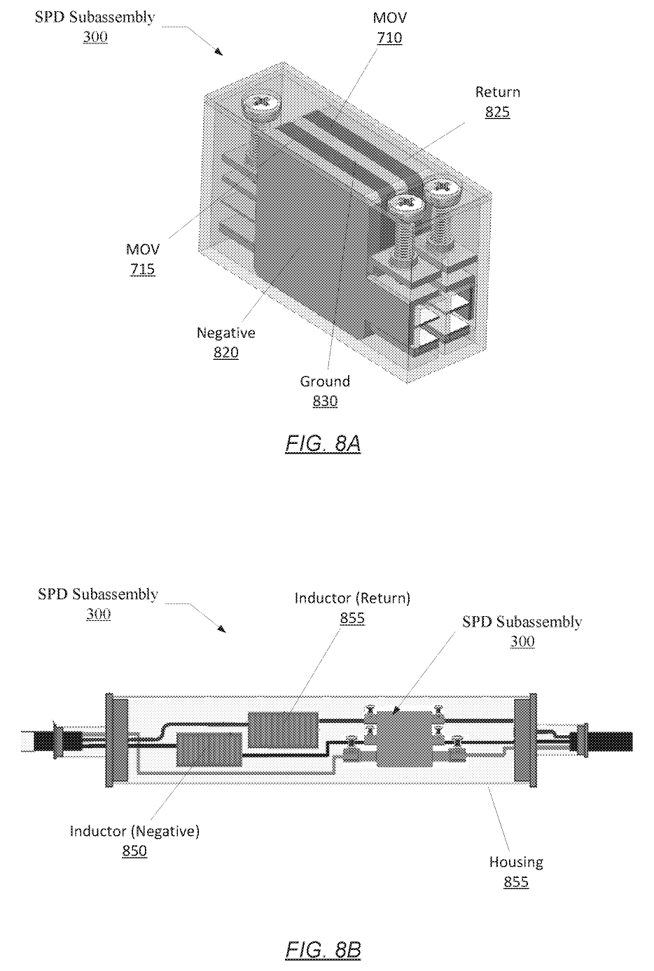

FIGS. 8A–8B illustrate an in-line cable integration in which an SPD subassembly (300), previously described with reference to FIGS. 3 and 7, is incorporated into a cable housing together with series inductive components. FIG. 8A depicts a perspective view of the SPD subassembly (300) and associated external connection regions, and FIG. 8B depicts an example in-line assembly in which the SPD subassembly (300) is disposed within a housing (855) along with an inductor (negative) (850) and an inductor (return) (855).

The SPD subassembly (300) is shown in FIG. 8A as a packaged stacked assembly having external connection regions corresponding to line conductors and a ground conductor. In FIG. 8B, one or more SPD subassemblies (300) are positioned within the housing (855) along a cable run, such that the SPD subassembly (300) is electrically coupled to conductors routed through the housing (855).

The MOV (710) is disposed within the SPD subassembly (300) and is positioned to provide a clamping path between a line-side node and a ground-side node defined by internal ground plate structure of the stacked arrangement. The MOV (710) is electrically coupled to a conductor plate associated with a line-side connection and is electrically coupled to a ground plate associated with the ground connection (830), such that surge current can be diverted from the line-side node toward the ground connection (830).

The MOV (715) is disposed within the SPD subassembly (300) and is positioned to provide an additional clamping path within the stacked arrangement. In some implementations, the MOV (715) is arranged as a second MOV element within the packaged stack such that the return-side and negative-side connections each have a defined discharge path to the ground connection (830) through a respective MOV element and internal ground plate structure.

The negative connection (820) defines a line-side connection region for coupling a negative conductor to the SPD subassembly (300). In FIG. 8A, the negative connection (820) is presented at an exterior side of the SPD subassembly (300) and is coupled to a negative-side conductor plate of the stacked arrangement. In FIG. 8B, the negative conductor is routed through the housing (855) such that the negative conductor is electrically continuous along the cable run while being electrically coupled to the SPD subassembly (300).

The return connection (825) defines a line-side connection region for coupling a return conductor to the SPD subassembly (300). In FIG. 8A, the return connection (825) is presented at an exterior side of the SPD subassembly (300) and is coupled to a return-side conductor plate of the stacked arrangement. In FIG. 8B, the return conductor is routed through the housing (855) such that the return conductor is electrically continuous along the cable run while being electrically coupled to the SPD subassembly (300).

The ground connection (830) defines a ground-side connection region for coupling a ground conductor to the SPD subassembly (300). In FIG. 8A, the ground connection (830) is presented at an exterior side of the SPD subassembly (300) and is coupled to an internal ground plate of the stacked arrangement. In use, the ground connection (830) provides a discharge node for surge current conducted through the MOV (710) and the MOV (715).

The inductor (negative) (850) is disposed within the housing (855) of FIG. 8B and is coupled in series with the negative conductor routed through the housing (855). The inductor (negative) (850) is positioned upstream or downstream of the SPD subassembly (300) along the cable run within the housing (855), such that transient current components on the negative conductor encounter the inductor (negative) (850) as the conductor passes through the in-line assembly.

The inductor (return) (855) is disposed within the housing (855) of FIG. 8B and is coupled in series with the return conductor routed through the housing (855). The inductor (return) (855) is positioned within the housing (855) at a location spaced from the SPD subassembly (300) to accommodate conductor routing and packaging constraints within the in-line assembly, while maintaining series coupling to the return conductor.

The housing (855) encloses the SPD subassembly (300), the inductor (negative) (850), and the inductor (return) (855) and defines an in-line assembly configured to be incorporated into a radio power cable. The housing (855) provides an interior region for routing the negative and return conductors through the in-line assembly and for coupling a ground conductor to the ground connection (830), and the housing (855) includes opposing end regions through which the conductors enter and exit the in-line assembly.

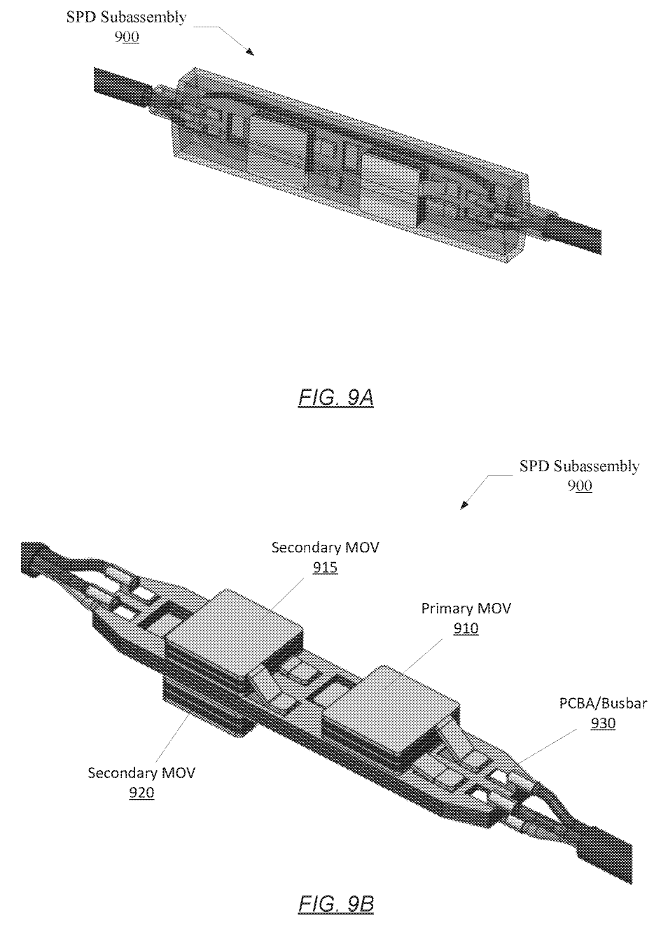

FIGS. 9A–9B illustrate an SPD subassembly (900) implemented as a multi-stage assembly supported by a multi-layer printed circuit board assembly (PCBA) and/or busbar, and configured for integration into a power cable segment. FIG. 9A depicts the SPD subassembly (900) in an in-line, cable-integrated form factor. FIG. 9B depicts the SPD subassembly (900) with an exposed PCBA/busbar structure and multiple MOV elements arranged along a length of the structure.

The SPD subassembly (900) is arranged such that multiple MOV elements are carried by a PCBA/busbar and positioned along a cable direction to form a staged surge suppression architecture. In some implementations, the SPD subassembly (900) is positioned near an equipment end of a power cable, such that a length of unprotected conductor between the SPD subassembly (900) and the protected equipment is reduced relative to installation at a distant junction location.

The primary MOV (910) is mounted to the PCBA/busbar (930) and is electrically coupled as a first-stage suppression element. In the staged arrangement, the primary MOV (910) is configured to conduct surge current for surge events that create a voltage differential between a line conductor and a ground reference, such that surge energy is diverted through the primary MOV (910) to a discharge path associated with the ground reference.

The secondary MOV (915) is mounted to the PCBA/busbar (930) and is electrically coupled as an additional suppression element downstream of the primary MOV (910) along the PCBA/busbar (930) length. In some implementations, the secondary MOV (915) is configured to provide continued clamping behavior when the primary MOV (910) has degraded or opened, and the secondary MOV (915) can be selected to have a voltage protection rating different from the primary MOV (910) to implement staged response across the multi-MOV architecture.

The secondary MOV (920) is mounted to the PCBA/busbar (930) and is spaced from the secondary MOV (915) and the primary MOV (910) along the PCBA/busbar (930). In some implementations, the secondary MOV (920) is electrically coupled to provide a second secondary stage, such that the staged arrangement includes at least one primary stage and at least two secondary stages, and the multiple stages act in a cascading configuration to further attenuate surge-related voltage components prior to reaching an equipment-side end of the cable segment.

The PCBA/busbar (930) supports the primary MOV (910) and the secondary MOVs (915, 920) and provides conductor routing between a tower-side cable end and an equipment-side cable end. In some implementations, the PCBA/busbar (930) is implemented as a multilayer structure providing distributed conductive paths and interconnect features for coupling the MOV elements to return, negative, and ground conductors, while maintaining a planar mounting region that positions the MOV elements in a linear arrangement along the PCBA/busbar (930).

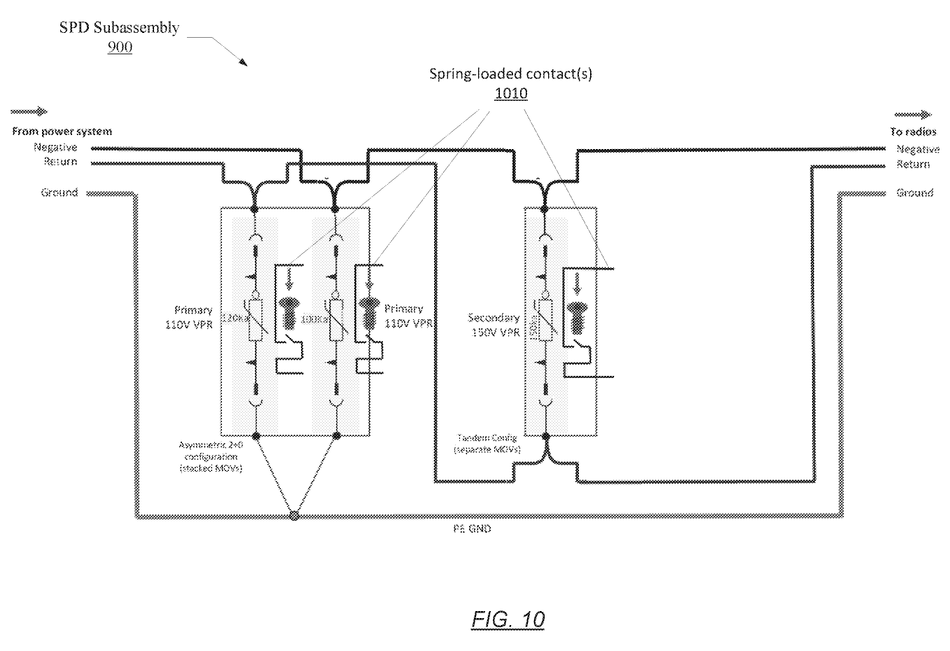

FIG. 10 illustrates the SPD subassembly (900) as an electrical schematic representation of a multi-stage surge suppression architecture disposed in-line between a power system and a radio-side load, with negative and return conductors extending through the SPD subassembly (900) and a ground conductor coupled to protective earth (PE GND).

The SPD subassembly (900), previously introduced with reference to FIG. 9, includes a primary protection stage configured to divert surge current to PE GND for surge events that create a voltage differential between at least one of the return conductor or the negative conductor relative to ground. In the illustrated arrangement, the primary protection stage is implemented using stacked MOV elements coupled between the return-to-ground and/or negative-to-ground nodes, such that the primary protection stage provides a defined discharge path to ground during a surge event.

The SPD subassembly (900) further includes a secondary protection stage configured to clamp surge-generated voltage differentials between the return conductor and the negative conductor. In this configuration, the secondary protection stage is electrically positioned between the return and negative circuits, such that the secondary protection stage addresses differential surge conditions that may remain after diversion of surge energy through the primary protection stage.

In some implementations, the primary protection stage is configured to mitigate a substantial portion of surge exposures over an operating life of the SPD subassembly (900), while the secondary protection stage is configured to provide continued clamping in the event of a primary-stage failure until service replacement is performed. In an example parameter set, the primary protection stage is associated with a first voltage protection rating (VPR) and the secondary protection stage is associated with a second VPR that is higher than the first VPR, such that the secondary protection stage is configured for operation as a backup clamping stage following failure of at least one primary MOV element.

The spring-loaded contact(s) (1010) are associated with the SPD subassembly (900) and are configured as contact closure elements that change an electrical continuity state in response to a failure condition associated with at least one MOV of the SPD subassembly (900). In the schematic representation, the spring-loaded contact(s) (1010) are positioned to provide a closure event upon MOV failure, thereby enabling an alarm or fail signal indicating a loss of redundancy and/or a failure of an SPD circuit.

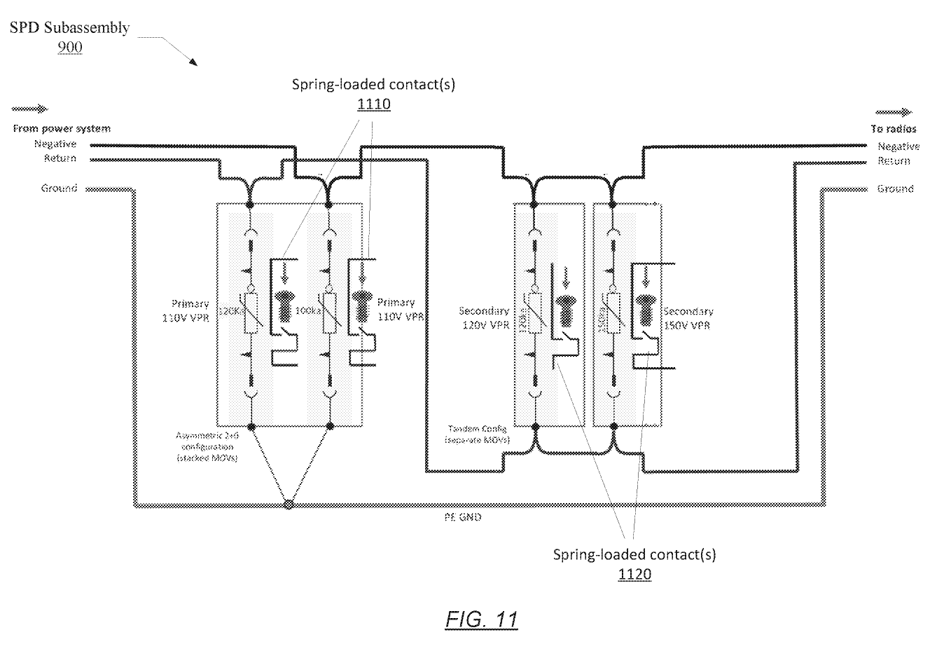

Referring now to FIG. 11, the SPD subassembly (900) is shown as an in-line, multi-stage surge suppression architecture electrically interposed between a power-system side and a radio side. In the illustrated schematic, a negative conductor and a return conductor extend through the SPD subassembly (900), and a ground conductor is coupled to a protective earth ground node (PE GND). The SPD subassembly (900) includes a primary suppression portion implemented as an asymmetric 2+0 stacked MOV configuration and a secondary suppression portion implemented as a tandem configuration using separate MOV elements, with the primary and secondary portions positioned at different locations along the conductor path.

In the depicted primary portion of the SPD subassembly (900), a plurality of primary MOV elements is coupled to clamp surge-generated voltage differentials that develop relative to ground. The primary portion is labeled as having a primary voltage protection rating (VPR) and includes at least two primary MOV elements with different maximum surge current ratings in the illustrated example (e.g., “120 kA” and “100 kA”), each arranged to conduct surge current toward PE GND during a surge event that drives a conductor node above a clamping threshold relative to ground.

In the depicted secondary portion of the SPD subassembly (900), one or more secondary MOV elements are coupled to clamp surge-generated voltage differentials between the negative conductor and the return conductor. The secondary portion is labeled as including at least a first secondary MOV having a first VPR (e.g., “Secondary 120V VPR”) and a second secondary MOV having a higher VPR (e.g., “Secondary 150V VPR”), and the illustrated example further identifies different maximum surge current ratings for the secondary MOV elements (e.g., “120 kA” and “150 kA”), consistent with a staged protection approach in which different MOV elements may be selected to provide different clamping thresholds and/or life characteristics.

The spring-loaded contact(s) (1110) are associated with the primary portion of the SPD subassembly (900) and are positioned to change an electrical continuity state in response to a failure condition associated with at least one primary MOV element. In some implementations, the spring-loaded contact(s) (1110) are configured to transition to a closed state when a primary MOV element opens or is mechanically released due to a failure mechanism, thereby enabling an alarm output indicating that a redundancy level associated with the primary protection portion has changed.

The spring-loaded contact(s) (1120) are associated with the secondary portion of the SPD subassembly (900) and are positioned to change an electrical continuity state in response to a failure condition associated with at least one secondary MOV element. In some implementations, the spring-loaded contact(s) (1120) provide a second alarm output that is distinct from the spring-loaded contact(s) (1110), such that different contact closures correspond to different failure states (e.g., loss of redundancy at a first stage versus failure of a protection circuit), and the contact closure is communicated to monitoring infrastructure as a failure indication.

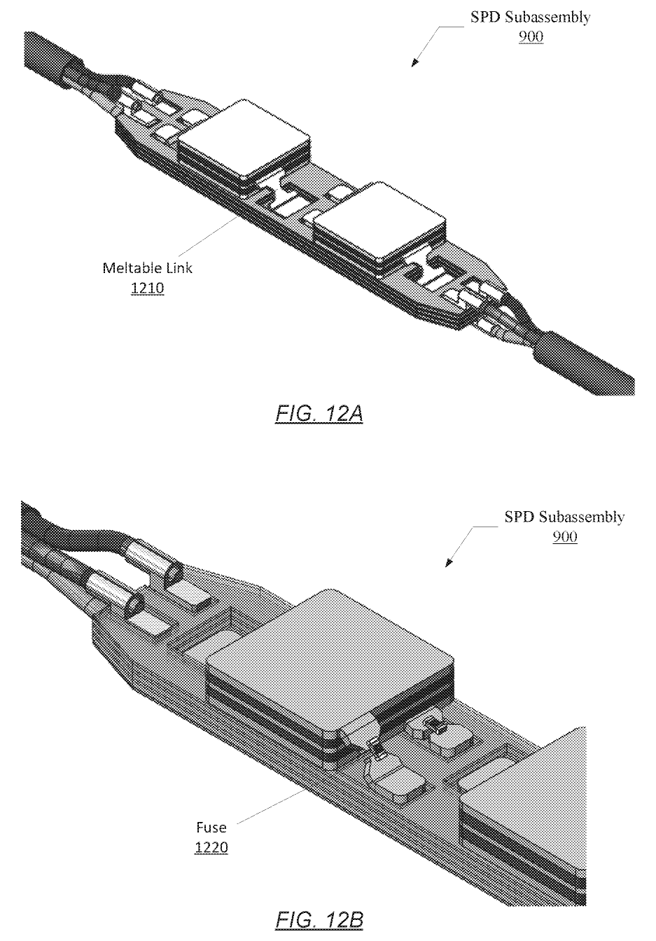

FIGS. 12A–12B illustrate the SPD subassembly (900) in an implementation that provides a disconnect feature for electrically isolating at least one MOV element from the protected circuit in response to a failure condition. FIG. 12A depicts a meltable link approach, and FIG. 12B depicts a fuse-based approach.

The SPD subassembly (900) is shown as a multi-component assembly arranged between cable-side conductors and equipment-side conductors. In the illustrated context, the SPD subassembly (900) is configured for integration into a cable segment, such that conductor terminations and internal conductive paths establish series continuity for the return and negative conductors while providing one or more discharge paths for surge current through the MOV-based suppression architecture.

The PCBA/busbar (930), previously introduced with reference to FIG. 9, provides a support and interconnect structure that carries the MOV elements and defines conductive routing between opposing ends of the in-line assembly. In FIGS. 12A–12B, the PCBA/busbar (930) presents mounting regions for MOV packages and further defines conductor-path segments that include a disconnect feature configured to open in response to a failure condition.

One or more MOV elements (e.g., a primary MOV (910) and one or more secondary MOVs (915, 920), previously described with reference to FIG. 9) are mounted to the PCBA/busbar (930) and are electrically coupled between a line-side node and a ground reference node and/or between line conductors, depending on the staged circuit configuration. In FIGS. 12A–12B, the MOV packages are disposed on the PCBA/busbar (930) with electrode connections routed through defined conductive paths that include, in the illustrated variants, an opening mechanism that is configured to interrupt current flow through a failed MOV.

The meltable link (1210) is shown in FIG. 12A as an opening feature integrated into a conductor path associated with the SPD subassembly (900). In some implementations, the meltable link (1210) is formed as a reduced-cross-section region of a conductive member that is electrically in series with an MOV connection, such that heating attributable to MOV degradation and sustained conduction causes the reduced-cross-section region to melt and thereby open the circuit path to the MOV. In this manner, the meltable link (1210) provides a structural opening mechanism that disconnects a failed MOV without reliance on a separate solder-release element.

The fuse (1220) is shown in FIG. 12B as a discrete opening component mounted on the PCBA/busbar (930) and electrically coupled in series with an MOV connection. In some implementations, the fuse (1220) is selected and positioned so that, when a failed MOV exhibits excessive thermal or electrical stress, the fuse (1220) opens and interrupts current flow through the failed MOV, thereby reducing continued heating at the failed MOV location and electrically isolating the failed MOV from the protected circuit path. The fuse (1220) may be integrated within a PCB portion of the PCBA/busbar (930) or coupled as a surface-mounted component, and a board-mounted implementation can also support routing of additional traces for monitoring or alarm signaling.

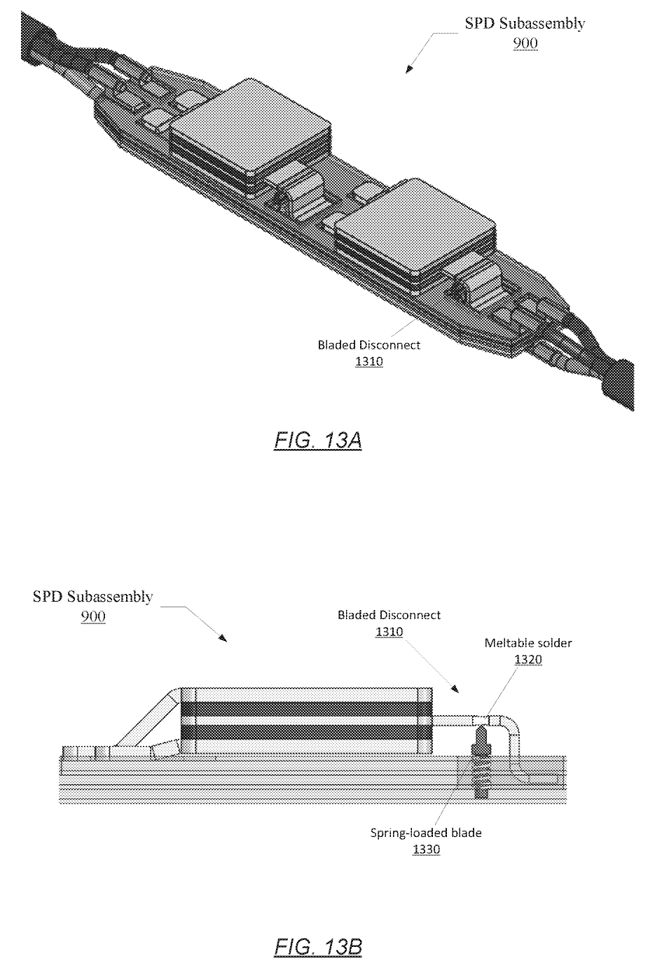

FIGS. 13A–13B illustrate the SPD subassembly (900) including a disconnect arrangement implemented as a bladed disconnect (1310). FIG. 13A depicts the SPD subassembly (900) in an in-line assembly format. FIG. 13B depicts a sectional view through a portion of the SPD subassembly (900) in the region of the bladed disconnect (1310), showing a conductive solder element (1320) and a spring-loaded blade (1330).

The SPD subassembly (900) is arranged along a conductor direction between opposing cable ends such that at least one conductor path segment extends through the SPD subassembly (900) between a power-system side and an equipment side. The bladed disconnect (1310) is disposed along the conductor path segment associated with at least one MOV-based suppression element, such that the conductor path segment can be opened in response to an event condition.

The bladed disconnect (1310) includes a conductive interface region configured to provide electrical continuity in a first state and to interrupt electrical continuity in a second state. In the illustrated arrangement, the first state is established by a soldered conductive connection, and the second state corresponds to a separated condition in which the soldered conductive connection is no longer continuous.

The conductive solder element (1320) is disposed at the disconnect region and provides the normal current-carrying conductive connection through the bladed disconnect (1310). In an installed state, the conductive solder element (1320) electrically couples between a conductive portion of the spring-loaded blade (1330) and a mating conductive region of the SPD subassembly (900), such that electrical continuity through the conductor path segment is provided through the conductive solder element (1320).

The spring-loaded blade (1330) includes a blade member and a spring member arranged to bias the blade member relative to a fixed structure of the bladed disconnect (1310). The spring member applies a force to the blade member in a direction that, when actuated, produces a separation movement at the disconnect region.

During operation, the conductor path segment remains electrically continuous through the conductive solder element (1320) until an event condition occurs. Upon a surge event, the spring-loaded blade (1330) is triggered to move relative to the mating conductive region such that the conductive solder element (1320) is broken, thereby interrupting the electrical connection at the disconnect region and opening the conductor path segment associated with the bladed disconnect (1310).

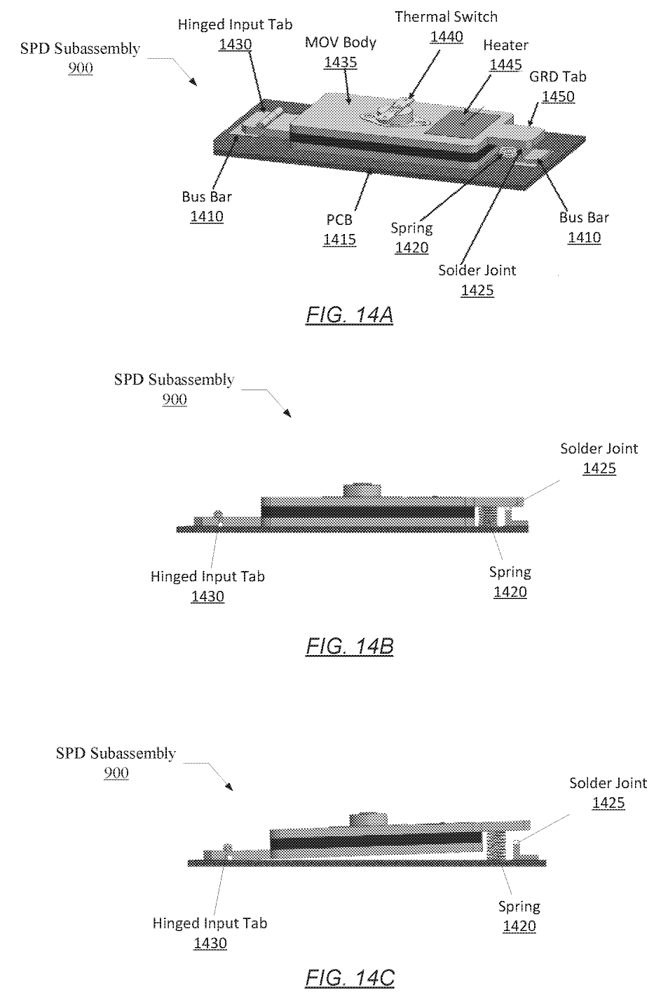

FIGS. 14A–14C illustrate an implementation of the SPD subassembly (900) in which an MOV body (1435) is mounted to a PCB (1415) and electrically coupled to one or more bus bars (1410), and in which a heater-driven, solder-release disconnect is used to mechanically separate an electrical connection upon a failure condition. FIG. 14A depicts a perspective view of the assembly and identifies component placement. FIGS. 14B–14C depict side views corresponding to different operating states of the disconnect region.

The bus bar (1410) is positioned on the PCB (1415) and defines a conductive pathway coupled to the MOV body (1435) through a tabbed connection region. In the illustrated arrangement, a first bus bar (1410) is disposed at a first side of the MOV body (1435) proximate a hinged input tab (1430), and a second bus bar (1410) is disposed at a second side of the MOV body (1435) proximate a solder joint (1425), such that the bus bars (1410) provide line-side conductive interfaces for the MOV body (1435).

The PCB (1415) supports the bus bar(s) (1410), the MOV body (1435), and the disconnect components, and provides a structural substrate for maintaining relative position and alignment between the line-side conductor interfaces and the disconnect region. In some embodiments, the PCB (1415) carries traces and/or conductor features associated with monitoring and/or alarming functions, including routing associated with a thermal switch (1440) and heater (1445) mounted on the MOV body (1435).

The MOV body (1435) is mounted on the PCB (1415) and is positioned between the bus bar(s) (1410) to provide surge clamping when a surge event produces a voltage differential across the MOV body (1435). The MOV body (1435) is further arranged to cooperate with a disconnect mechanism such that, when a failure condition is detected, the MOV body (1435) is mechanically separated from at least one electrical interface to interrupt current flow through the MOV body (1435).

The hinged input tab (1430) is coupled to a side of the MOV body (1435) and provides a pivoting mechanical interface relative to the PCB (1415) and/or a bus bar (1410). In FIGS. 14B–14C, the hinged input tab (1430) is shown at a first end region of the MOV body (1435) such that the MOV body (1435) can rotate about the hinged input tab (1430) when an opposite end region is displaced by a spring (1420).

The solder joint (1425) is disposed proximate to a second end region of the MOV body (1435) and is configured to maintain electrical continuity between the MOV body (1435) and a bus bar (1410) while the solder joint (1425) remains intact. In some embodiments, the solder joint (1425) is positioned as a meltable retention interface that, upon liquefaction, releases the second end region of the MOV body (1435) and permits movement that interrupts the electrical connection at the solder-joint region.

The spring (1420) is positioned adjacent to the solder joint (1425) and is configured to bias the MOV body (1435) away from the PCB (1415) at the solder-joint end region. In FIG. 14B, the spring (1420) is shown in a constrained state while the solder joint (1425) maintains the connection. In FIG. 14C, the spring (1420) is shown in an expanded state after release of the solder joint (1425), thereby lifting the solder-joint end region of the MOV body (1435) and creating separation at the solder-joint interface while the hinged input tab (1430) constrains the opposite end region.

The thermal switch (1440) is mounted on the MOV body (1435) and is configured to transition states in response to a monitored condition associated with MOV operation. In some embodiments, the thermal switch (1440) is positioned to respond to leakage-current-related heating at the MOV body (1435) and to enable energization of the heater (1445) when a threshold condition is met.

The heater (1445) is mounted on the MOV body (1435), proximate the thermal switch (1440) and is configured to add heat to the disconnect region to accelerate release of the solder joint (1425) when a failure condition is detected. In some embodiments, the heater (1445) supplements heat generated by leakage current through the MOV body (1435), thereby reducing time to release of the solder joint (1425) and enabling a controlled transition from an electrically connected state to an electrically open state.

The ground tab (1450) is coupled to the MOV body (1435) and provides an electrical interface for coupling the MOV body (1435) to a ground conductor and/or ground structure within the SPD subassembly (900). In the illustrated arrangement, the ground tab (1450) extends laterally from the MOV body (1435) and is positioned adjacent to the heater (1445), such that the ground tab (1450) remains accessible as a ground connection region while the solder-joint end region is configured for separation during a disconnect event.

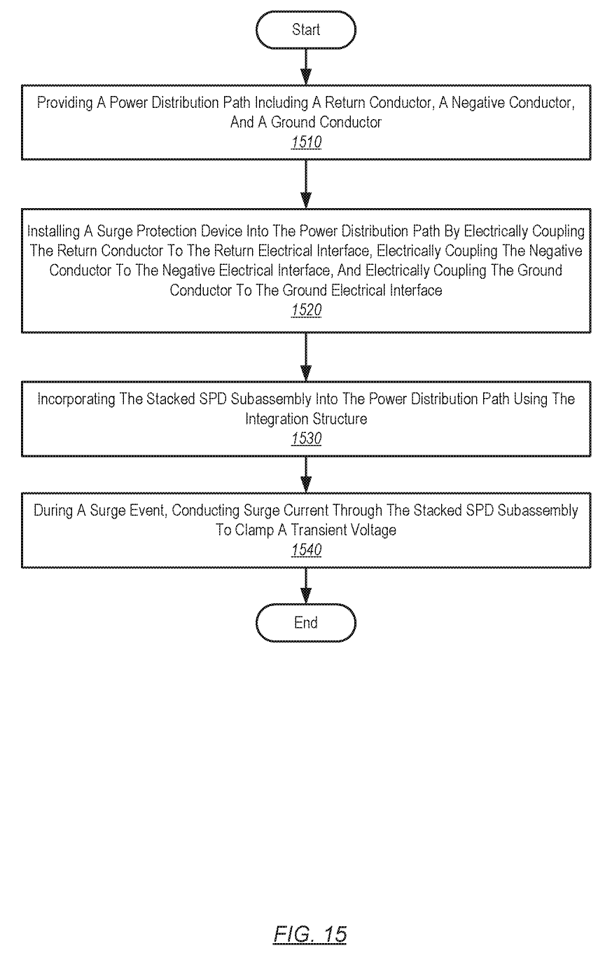

FIG. 15 is a flow diagram illustrating a method of surge protecting equipment, including providing a power distribution path, electrically coupling return/negative/ground interfaces, incorporating the stacked SPD subassembly using an integration structure, and clamping a transient voltage during a surge event.

At Step 1510, a power distribution path is provided, including a return conductor, a negative conductor, and a ground conductor. Step 1510 includes establishing, identifying, or otherwise providing a power distribution path having at least a return conductor, a negative conductor, and a ground conductor. In one implementation context, the power distribution path is part of a wireless communications installation in which DC power is routed from a power system toward tower-top or equipment-side electronics, and the return and negative conductors are routed as the protected conductors while the ground conductor provides a protective earth reference for surge diversion.

In implementing step 1510, the conductors may be provided as discrete conductors, as conductors within a jacketed cable, or as conductive paths implemented by a busbar or a printed circuit board assembly. The “providing” operation may include routing the conductors through one or more enclosures and/or selecting a cable segment in which surge suppression is to be integrated, including selecting an equipment-adjacent portion of the run to reduce an exposed length of conductor between the surge protection device and the protected equipment.

At step 1520, a surge protection device is installed into the power distribution path by electrically coupling the return conductor to the return electrical interface, electrically coupling the negative conductor to the negative electrical interface, and electrically coupling the ground conductor to the ground electrical interface

Step 1520 includes installing the surge protection device into the power distribution path by forming electrical couplings between the return conductor and a return electrical interface, between the negative conductor and a negative electrical interface, and between the ground conductor and a ground electrical interface. In practice, the electrical interfaces are implemented as conductive plates, terminal plates, busbars, contact pads, or other conductive structures that define entry/exit nodes of the surge protection device and that place the protected conductors in electrical communication with a stacked MOV arrangement contained within the device.

In one implementation, step 1520 includes placing the return and negative conductors into direct electrical communication with corresponding conductor-plate interfaces of the stacked MOV arrangement and placing the ground conductor into direct electrical communication with a ground-plate interface, thereby reducing series path length and reducing directional changes between a customer connection region and the MOV conductor plate region. In another implementation, step 1520 includes seating the surge protection device into a base that provides blind-mate contact structure, spring contacts, and/or screw-down terminations, while still preserving a defined interface mapping of return-to-return, negative-to-negative, and ground-to-ground.

At Step 1530, the stacked SPD subassembly is incorporated into the power distribution path using the integration structure

Step 1530 includes incorporating the stacked SPD subassembly into the power distribution path using an integration structure that physically supports the stacked MOV arrangement and maintains the electrical interface couplings established in step 1520. The integration structure may be implemented as an in-line housing disposed along a cable segment, as a plug-in module retained by a base, or as a PCBA/busbar assembly disposed within an enclosure or cable-adjacent package, with each integration structure configured to protect the stacked MOV arrangement and preserve conductor routing between a power-system side and an equipment side.

Step 1530 may further include selecting an in-line cable integration structure that positions the stacked MOV arrangement within an environmentally protective tube or housing and installing one or more inductors in series with at least one of the negative conductors or the return conductor within the same in-line assembly. In this implementation, the inductors are integrated into the in-line assembly so that surge-current rise time and/or transient energy propagation along the conductors is shaped before and/or during clamping by the stacked MOV arrangement, while the assembly remains deployable as part of a radio power cable.

At Step 1540, surge current is conducted through the stacked SPD subassembly to clamp a transient voltage during a surge event. Step 1540 includes, during a surge event, conducting surge current through the stacked SPD subassembly such that a transient voltage is clamped by the stacked MOV arrangement. In operation, when a surge produces a voltage differential between at least one protected conductor and ground, or between the protected conductors, the stacked MOV arrangement transitions from a high-impedance state to a conduction state and provides a surge diversion path through internal conductor-plate and ground-plate structures, thereby limiting a voltage appearing at an equipment-side portion of the power distribution path.

Step 1540 may further include producing a failure indication when an MOV reaches a failure condition, including changing an electrical continuity state of a spring-loaded contactor to generate a failure signal to monitoring infrastructure. Step 1540 may additionally include isolating a failed MOV from the power distribution path by actuating a disconnect arrangement responsive to a surge-induced fault or thermal condition, including opening a conductive path using a meltable link, a fuse, a solder-release mechanism with a spring-driven separator, and/or a blade-based disconnect that breaks a conductive solder joint to interrupt the electrical connection.

The present disclosure provides surge protection devices and methods that organize surge suppression around a stacked metal oxide varistor (MOV) subassembly configured for coupling to return, negative, and protective earth ground conductors in a power distribution path. The stacked subassembly includes opposing conductor plates and one or more ground plates within the stack to define a surge discharge path to ground and may include multiple MOV layers arranged with one or more internal ground plates and optional thermal separation features. The stacked subassembly is configured as a reusable surge suppression core that can be incorporated into different physical integration structures while maintaining the same fundamental electrical coupling strategy between protected conductors and the ground discharge node.

In various implementations, the stacked MOV subassembly is integrated into a plug-in housing configured for installation in a junction enclosure, an inline cable housing configured for integration into a power cable segment, and/or a multilayer printed circuit board assembly or laminated busbar supporting one or more stacked subassemblies along a length of the support structure. The disclosure further supports staged protection architectures in which a primary stage is coupled relative to protective earth and a secondary stage is coupled between return and negative, and the disclosure supports optional series inductive elements located within the same inline housing as the stacked subassembly. These structures enable deployment configurations that place surge suppression closer to a protected interface than arrangements limited to centralized enclosure installations and enable packaging and routing approaches that reduce conductor-path length and complexity between line conductors, the clamp elements, and the ground discharge node.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms "before", "after", "single", and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the term “or” is an “inclusive or” and, as such includes the term “and.” Further, items joined by the term “or” may include any combination of the items with any number of each item unless, expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A stacked surge protection device (SPD) subassembly, comprising:
a stacked assembly including a plurality of metal oxide varistor (MOV) layers including at least a first MOV layer and a second MOV layer;
a return conductor plate disposed at a first outer side of the stacked assembly;
a negative conductor plate disposed at a second outer side of the stacked assembly opposite the first outer side;
at least one ground plate disposed within the stacked assembly between the return conductor plate and the negative conductor plate; and
a return terminal electrically coupled to the return conductor plate, a negative terminal electrically coupled to the negative conductor plate, and a ground terminal electrically coupled to the at least one ground plate.

2. The stacked SPD subassembly of claim 1, wherein the at least one ground plate is interposed between the first MOV layer and the second MOV layer.

3. The stacked SPD subassembly of claim 1, wherein the stacked assembly includes at least a third MOV layer and a respective ground plate interposed between adjacent MOV layers.

4. The stacked SPD subassembly of claim 1, wherein the at least one ground plate comprises:
a plurality of ground plates including a respective ground plate for at least two different MOV layers, or a single shared ground plate layer common to at least two different MOV layers.

5. The stacked SPD subassembly of claim 4, wherein at least two ground plates of the plurality of ground plates are in contact with one another and are not bonded to one another.

6. The stacked SPD subassembly of claim 1, further comprising:
a thermally insulative separation layer disposed between adjacent MOV layers in the stacked assembly.

7. The stacked SPD subassembly of claim 1, wherein at least one of the return conductor plate or the negative conductor plate has a thickness in a range from 2 millimeters to 3 millimeters.

8. The stacked SPD subassembly of claim 1, wherein the ground terminal includes a plurality of ground tabs electrically coupled together as a common ground output.

9. The stacked SPD subassembly of claim 1, further comprising:
at least one coupling feature electrically connected to at least one of the return conductor plate, the negative conductor plate, or the at least one ground plate, the coupling feature including at least one tab, blade, pad, spring contact, or blind-mate spring clip.

10. The stacked SPD subassembly of claim 1, further comprising:
a protective coating disposed over at least a portion of the stacked assembly.

11. A surge protection device (SPD), comprising:
a stacked SPD subassembly including a stacked assembly having a plurality of MOV layers, a return conductor plate and a negative conductor plate disposed at opposing outer sides of the stacked assembly, and at least one ground plate disposed within the stacked assembly;
a return electrical interface electrically coupled to the return conductor plate, a negative electrical interface electrically coupled to the negative conductor plate, and a ground electrical interface electrically coupled to the at least one ground plate;
an integration structure configured to incorporate the stacked SPD subassembly into a power distribution path; and
a contactor assembly including (i) a fixed contact, (ii) a movable contact, and(iii) a spring biasing the movable contact relative to the fixed contact, the contactor assembly being configured to change an electrical continuity state between the fixed contact and the movable contact in response to a failure condition associated with at least one MOV layer of the stacked SPD subassembly.

12. The SPD of claim 11, wherein the integration structure comprises:
a plug-in module housing configured for installation in a junction box, andwherein at least one of the return electrical interface, the negative electrical interface, or the ground electrical interface comprises a blind-mate spring contact.

13. The SPD of claim 11, wherein the integration structure comprises:an inline cable housing enclosing the stacked SPD subassembly and configured to be installed inline with a power cable, the inline cable housing having a length greater than a width of the inline cable housing.

14. The SPD of claim 11, wherein the integration structure comprises:a multilayer printed circuit board assembly (PCBA) or a laminated busbar supporting the stacked SPD subassembly.

15. The SPD of claim 14, wherein the multilayer PCBA or the laminated busbar supports a plurality of stacked SPD subassemblies arranged in a linear fashion along a length of the multilayer PCBA or the laminated busbar to define:
a primary surge suppression stage electrically coupled between at least one of a return conductor or a negative conductor and a ground conductor; and
a secondary surge suppression stage electrically coupled between the return conductor and the negative conductor.

16. The SPD of claim 11, further comprising:
a disconnect arrangement configured to electrically isolate at least one failed MOV layer from the power distribution path, the disconnect arrangement including at least one of:
a fuse or fusible link;
a meltable solder joint cooperable with a spring-loaded member to mechanically separate an electrical interface upon melting of the meltable solder joint;
a fusible region of an MOV body; or
a thermal switch and a heater arranged to initiate disconnection in response to a leakage-current condition satisfying a threshold.

17. A method of surge protecting wireless communications equipment, comprising:
providing a power distribution path including a return conductor, a negative conductor, and a ground conductor;
installing the surge protection device of claim 11 into the power distribution path by electrically coupling the return conductor to the return electrical interface, electrically coupling the negative conductor to the negative electrical interface, and electrically coupling the ground conductor to the ground electrical interface;
incorporating the stacked SPD subassembly into the power distribution path using the integration structure; and
during a surge event, conducting surge current through the stacked SPD subassembly to clamp a transient voltage.

18. The method of claim 17, wherein incorporating comprises:enclosing the stacked SPD subassembly within an inline cable housing of an inline cable segment positioned adjacent an equipment end of a power cable; andelectrically coupling at least one inductor in series with at least one of the return conductor or the negative conductor within the inline cable housing.

19. The method of claim 17, further comprising:generating a failure indication by changing the electrical continuity state of the contactor assembly.

20. The method of claim 17, further comprising:
electrically isolating at least one failed MOV layer by actuating the disconnect arrangement.
